(19) United States
(12) Patent Application Publication
(10) Pub. No.: US 2025/0341118 A1
(43) Pub. Date: Nov. 6, 2025

(54) LATCH MECHANISM

(71) Applicant: ELECTROLATCH (PTY) LTD, Sandton (ZA)

(72) Inventors: Christiaan Johannes Hendrik SERFONTEIN, Sandton (ZA); Dennis Mark HOLDEN, Sandton (ZA); Luan STEYN, Sandton (ZA); Nicholas Daniel POPICH, Sandton (ZA)

(73) Assignee: ELECTROLATCH (PTY) LTD, Sandton (ZA)

(21) Appl. No.: 18/871,065

(22) PCT Filed: May 31, 2023
(86) PCT No.: PCT/IB2023/055594

§ 371 Date: Dec. 2, 2024

(30) Foreign Application Priority Data
May 31, 2022 (ZA) 2022/06027

(51) Int. Cl. E05B 57/00; E05B 7/00; E05B 47/00

(52) U.S. Cl. CPC E05B 57/00; E05B 7/00; E05B 47/0012; E05B 2047/002; E05B 2047/0084

(57) ABSTRACT

A latch mechanism (10) in the form of a pressure plate latch or pressure lever lock or latch mechanism comprising a latch body (20) and a lock mechanism (32) comprising a first displaceable lock body (38). The lock mechanism (32) defines a lock opening (34) and is configurable in a locked configuration and unlocked configuration. When in the unlocked configuration, the lock opening (34) is open allowing a portion of the latch body (20) to be displaced thereinto to cause the latch body (20) to unlatch from a catch formation (24). When in the locked configuration. the first lock body (38) is displaced at least partially into the lock opening (34), thereby inhibiting the portion of the latch body (20) from being displaced into the lock opening (34). The latch mechanism (10) furthermore comprises an automated actuating mechanism (44) for displacing the first lock body (38).

### BACKGROUND TO THE INVENTION

This invention relates to a latch mechanism. More particularly, the present invention relates to pressure plate latch or pressure lever lock or latch mechanism with an automatic or electronic actuating locking arrangement. The invention further relates to a structure incorporating a latch system including one or more such latch mechanisms.

Latches are commonly used in a wide variety of applications, releasably to retain movable parts of a structure relative to stationary parts thereof. For example, latches are typically used to retain doors in a closed configuration relative to a larger structure.

A pressure plate latch or pressure lever lock or latch mechanism is a robust and heavy- duty latch which is configured the be relatively flush with an outer surface of a structure to which it is mounted, with most of its working components arranged towards an inner volume of the structure. Because of this, the latch is more concealed than typical externally facing latches, and as a result, relatively tamperproof. Furthermore, since the pressure plate latch is relatively flush with the outer surface of the structure, same is frequently selected in applications where aerodynamic drag is to be avoided. For example, the use of pressure plate latches on doors of hardware fitted to or associated with road-going vehicles have grown in popularity. Specifically, pressure plate latches are frequently used on canopies of pickup-trucks, on commercial vehicles, and on trailers and caravans towed by road-going vehicles.

A pressure plate latch has an externally facing pressure plate. To release the latch, the pressure plate is pressed to release a latch body from a catch formation. The pressure plate latch is lockable. Typically, a lock body is provided which can be actuated between a locked and unlocked configuration, using a key. It will be appreciated that the lock body is situated towards the inside of the latch and is therefore concealed under normal operating conditions.

When in the locked configuration, the lock body physically interferes with a portion of the latch body, to prevent same from unlatching from the catch formation, and therefore, preventing the pressure plate from being pressed or actuated.

When in the unlocked configuration the lock body is displaced away from the latch body, such that the lock body can be actuated without interference, allowing same to become unlatched from the catch formation.

Typically, a structure such as a caravan or canopy includes a number of pressure plate latches. A need exists for a system allowing easier locking and/or unlocking of one or more pressure plate latches.

In cases where pressure plate latches are used with caravans or other structures or dwellings where persons may, from time to time, be located on an inside, the use of a pressure plate latch is limited, due to its inability to be opened from the inside. Furthermore, if a pressure plate latch is locked while in an unlatched configuration, it is impossible properly to close the latch, due to internal interference between a lock body and an extension of a latch body of the latch. Proper implementation of pressure plate latches in the abovementioned circumstances calls for these limitations to be addressed.

It is accordingly an object of the invention to provide a latch mechanism and a structure incorporating a latch system comprising one or more of said latch mechanisms which will, at least partially, address the above disadvantages or needs.

It is also an object of the invention to provide a latch mechanism and a structure incorporating a latch system comprising one or more of said latch mechanisms which will be a useful alternative to existing latch mechanisms and systems.

### SUMMARY OF THE INVENTION

In accordance with a first aspect of the invention there is provided a latch mechanism comprising a latch body and a lock mechanism comprising first and second lock bodies which are displaceable independently relative to each other, the lock mechanism defining a lock opening and being configurable in one of:
an unlocked configuration, in which the lock opening is open allowing a portion of the latch body to be displaceable thereinto to cause the latch body to unlatch from a catch formation; and
a locked configuration, in which at least one of the first and second lock bodies is displaced at least partially into the lock opening, thereby inhibiting the portion of the latch body from being displaced into the lock opening.

The first and second lock bodies may be pivotably displaceable relative to each other about an axis of rotation. Each of the first and second lock bodies may have a cross-sectional shape of a ring segment. Alternatively, one or more of the first and second lock bodies may comprise a pin having a substantially circular cross-sectional shape. Each of the first and second lock bodies may be displaceable between an active and inactive configuration. When the first and second lock bodies are configured in their respective inactive configurations, the first and second lock bodies may be located proximate each other in adjoining fashion, without physical interference between the first and second lock bodies, while defining between them, the open lock opening.

The first lock body may be pivotably supported relative to a main body of the latch mechanism. The second lock body may be pivotably supported by a handle portion of the latch.

Further in accordance with the first aspect of the invention, the latch mechanism may comprise an automated actuating mechanism for displacing the first lock body. The automated actuating mechanism may comprise an electronic actuating mechanism comprising an electric motor associated with a gear arrangement, the gear arrangement configured to displace the first lock body. The gear arrangement may have a gear ratio selected to ensure a sufficient amount of torque is exerted on the first lock body to pivotably displace same between active and inactive configurations. The gear ratio is between 1:40 and 1:100. In some examples, the gear ratio may be about 1:49 or about 1:90. The gear arrangement may comprise one of a bevel gear arrangement, spur gear arrangement, worm gear arrangement, spur and crown arrangement, rack and pinion arrangements and a multistage gear arrangement.

The automated actuating mechanism may be received within a housing which may be fixed to a main body of the latch mechanism and wherein the first lock body or a drive body associated with the first lock body may extend at least partially through an opening in the main body of the latch mechanism.

The first lock body or the drive body may be supported by a support ring which may extend from the housing. The support ring may comprise a limiting formation, provided for interacting with a complementary shoulder or stopper formation on the first lock body or drive body, for limiting a range of permissible displacement of the first lock body.

The latch mechanism may further comprise a control unit operatively connected to a power source and including a receiving means in the form of a radio receiver, configured for receiving a signal, such as a radio frequency (RF) signal, an RFID signal, a WIFI signal, a Bluetooth signal, and an IoT signal, from a command module. The control unit may be configured for causing the electric motor to actuate the first lock body based on a command received from the command module.

The second lock body may be configured to be actuated by external means in the form of a key which is turned to displace the second lock body between active and inactive configurations.

The latch mechanism may take the form of a pressure plate latch mechanism or pressure lever lock or latch mechanism.

Further in accordance with the first aspect of the invention, the catch formation may be formed on a catch body which may be displaceable relative to a main body of the latch mechanism between an operative and inoperative position. The catch body may be biased towards the operative position. Furthermore, the catch body may comprise an extension which extends through an opening in the main body and defines a handle portion, facilitating manual displacement of the catch body towards the inoperative position.

The catch body may be pivotably displaceable, axially displaceable, sideways-slidably displaceable or rotatably displaceable relative to the main body. An automated actuating mechanism may be provided for displacing the catch body between the operative and inoperative positions.

Alternatively, a displaceable actuating lever may extend from a rear side of the latch mechanism in such as a way as to interact with the latch body. The actuating lever may be used to displace the latch body to unlatch from the catch formation.

Further in accordance with the first aspect of the invention, one of the first and second lock bodies is axially displaceable between an extended and retracted position, and wherein the relevant one of the first and second lock bodies is biased towards the extended position. The relevant one of the first and second lock bodies may comprise a lock pin which is supported by a lock body support collar.

In accordance with a second aspect of the invention there is provided a latch mechanism comprising a latch body and a lock mechanism comprising a first displaceable lock body, the lock mechanism defining a lock opening and being configurable in one of
an unlocked configuration, in which the lock opening is open allowing a portion of the latch body to be displaceable thereinto to cause the latch body to unlatch from a catch formation; and
a locked configuration, in which the first lock body is displaced at least partially into the lock opening, thereby inhibiting the portion of the latch body from being displaced into the lock opening,
the latch mechanism further comprising an automated actuating mechanism for displacing the first lock body.

The automated actuating mechanism may comprise an electronic actuating mechanism comprising an electric motor associated with a gear arrangement. The gear arrangement may be configured to displace the first lock body.

The gear arrangement may have a gear ratio selected to ensure a sufficient amount of torque is exerted on the first lock body to pivotably displace same between active and inactive configurations. The gear ratio is between 1:40 and 1:100. In some examples, the gear ratio may be about 1:49 or about 1:90. The gear arrangement may comprise one of a bevel gear arrangement, spur gear arrangement, worm gear arrangement, spur and crown arrangement, rack and pinion arrangements and a multistage gear arrangement.

The automated actuating mechanism may be received within a housing which is fixed to a main body of the latch mechanism. The first lock body or a drive body associated with the first lock body may extend at least partially through an opening in the main body of the latch mechanism.

The first lock body or the drive body may be supported by a support ring which extends from the housing. The support ring may comprise a limiting formation, provided for interacting with a complementary shoulder or stopper formation on the first lock body or drive body, for limiting a range of permissible displacement of the first lock body.

The latch mechanism may further comprise a control unit operatively connected to a power source and including a receiving means in the form of a radio receiver, configured for receiving a signal from a command module, wherein the signal is selected from a group comprising: a radio frequency (RF) signal, an RFID signal, a WIFI signal, a Bluetooth signal, and an IoT signal. The control unit may be configured for causing the electric motor to actuate the first lock body based on a command received from the command module.

Further in accordance with the second aspect of the invention, the latch mechanism according may comprise a second lock body which may be displaceable independently relative to the first lock body.

Again, the latch mechanism in accordance with the second aspect of the invention may take the form of a pressure plate latch mechanism or pressure lever lock or latch mechanism.

Further in accordance with the second aspect of the invention, the catch formation may be formed on a catch body which is displaceable relative to a main body of the latch mechanism between an operative and inoperative position. The catch body may be biased towards the operative position. The catch body may comprise an extension which extends through an opening in the main body and defines a handle portion, facilitating manual displacement of the catch body towards the inoperative position.

The catch body may be pivotably displaceable, axially displaceable, sideways-slidably displaceable or rotatably displaceable relative to the main body. An automated actuating mechanism may be provided for displacing the catch body between the operative and inoperative positions.

Alternatively, a displaceable actuating lever may extend from a rear side of the latch mechanism in such as a way as to interact with the latch body. The actuating lever may be used to displace the latch body to unlatch from the catch formation.

One of the first and second lock bodies may be axially displaceable between an extended and retracted position. The relevant one of the first and second lock bodies may be biased towards the extended position.

The relevant one of the first and second lock bodies may comprise a lock pin which may be supported by a lock body support collar.

In accordance with a third aspect of the invention there is provided a latch mechanism comprising a latch body, a catch formation, and a lock mechanism comprising a first displaceable lock body, the lock mechanism defining a lock opening and being configurable in one of
an unlocked configuration, in which the lock opening is open allowing a portion of the latch body to be displaceable thereinto to cause the latch surface to unlatch from the catch formation; and
a locked configuration, in which the first lock body is displaced at least partially into the lock opening, thereby inhibiting the portion of the latch body from being displaced into the lock opening,
wherein the catch formation is formed on a catch body which is displaceable relative to a main body of the latch mechanism between an operative and inoperative position.

The catch body may be biased towards the operative position. The catch body may comprise an extension which may extend through an opening in the main body and may define a handle portion, facilitating manual displacement of the catch body towards the inoperative position.

The catch body may be pivotably displaceable, axially displaceable, sideways-slidably displaceable or rotatably displaceable relative to the main body. An automated actuating mechanism may be provided for displacing the catch body between the operative and inoperative positions.

Alternatively, a displaceable actuating lever may extend from a rear side of the latch mechanism in such as a way as to interact with the latch body. The actuating lever may be used to displace the latch body to unlatch from the catch formation.

Further in accordance with the third aspect of the invention, the latch mechanism may take the form of a pressure plate latch mechanism or pressure lever lock or latch mechanism.

In accordance with a fourth aspect of the invention there is provided a structure defining an internal volume, the structure including at least one door which is provided with one or more latch mechanisms in accordance with the first, second or third aspects of the invention.

The structure may furthermore comprise a control unit for controlling automated actuating mechanisms of the one or more latch mechanisms.

The structure may furthermore comprise at least a first sensor device provided in communication with the control unit. The control unit may be associated with a siren or alarm module. The first sensor device may be a motion detector device, a smoke detector device, a temperature sensing device or thermometer, a sound detector device, a door or window proximity sensor or a light sensor.

The structure may take the form of a canopy, a container, a trailer, a caravan, a camper, a pod, a car top carrier, a luggage box, a motor bike top box or pannier, a cubbyhole, a glove box, a cupboard, a service hatch, an access door, a toolbox, a security door, a flatbed tray, a gullwing door, a drawer, a safe, a safety deposit box, a slider, a load-bay cover of a pick-up truck, a roller door, a shutter or roller shutter a luggage compartment, a door and/or window of a dwelling, building or structure, typically such as dwellings, buildings or structures in areas with hostile climate conditions, such as high wind areas (for example pods used in Antarctica), a luggage compartment, or the like.

### BRIEF DESCRIPTION OF THE DRAWINGS

The invention will now be described in more detail, by way of example only, with reference to the accompanying drawings in which:

FIG. 1 shows a sectioned side view of a latch mechanism in accordance with a first example embodiment of the invention, in which the latch mechanism is configured in a latched configuration;

FIG. 2 shows a further sectioned side view of the latch mechanism of FIG. 1, in which a latch body is pivoted away from a catch formation, to allow the latch mechanism to be configured to an unlatched configuration;

FIG. 3 shows a further sectioned side view of the latch mechanism of FIG. 1, in FIG. 3 the unlatched configuration;

FIGS. 4 to 6 show partially sectioned top views of the latch mechanism of FIG. 1, showing various configurations of first and second lock bodies of a lock mechanism of the latch mechanism;

FIG. 7 shows a side view of the latch mechanism of FIG. 1;

FIG. 8 shows a top view of the latch mechanism of FIG. 1;

FIG. 9 shows a bottom view of the latch mechanism of FIG. 1;

FIG. 10 shows a schematic top view of the lock mechanism of the latch mechanism of FIG. 1, in which both the first and second lock bodies are configured in inactive configurations, to render the lock mechanism in an unlocked configuration;

FIG. 11 shows a further schematic top view of the lock mechanism of the latch mechanism of FIG. 1, in which the first lock body is configured in an active configuration, to render the lock mechanism in a locked configuration;

FIG. 12 shows a further schematic top view of the lock mechanism of the latch mechanism of FIG. 1, in which the second lock body is configured in an active configuration, to render the lock mechanism in a locked configuration;

FIGS. 13 to 15 show schematic perspective views of the schematic top views shown in FIGS. 10 to 12;

FIG. 16 shows a perspective view of a structure, in the form of a canopy of a pick-uptruck, incorporating an automated central locking and security system, which includes a control unit and a number of latch mechanisms of FIG. 1, fitted to doors of the canopy;

FIG. 17 shows a sectioned side view of a latch mechanism in accordance with a second example embodiment of the invention, in which the latch mechanism is configured in a latched configuration;

FIG. 18 shows a further sectioned side view of the latch mechanism of FIG. 17, in which a latch body is pivoted away from a catch formation, to allow the latch mechanism to be configured to an unlatched configuration;

FIG. 19 shows a further sectioned side view of the latch mechanism of FIG. 17, in the unlatched configuration;

FIG. 20 shows a top perspective view of an automated actuating mechanism forming part of the latch mechanism of FIG. 17;

FIG. 21 shows a bottom perspective view of the automated actuating mechanism of FIG. 20;

FIG. 22 shows a sectioned side view of the automated actuating mechanism of FIG. 20;

FIG. 23 shows a partial top view of the automated actuating mechanism of FIG. 20;

FIG. 24 shows a partial bottom view of the automated actuating mechanism of FIG. 20;

FIG. 25 shows a perspective view of an electric motor and multistage gear arrangement forming part of the automated actuating mechanism of FIG. 20, wherein the electric motor and multistage gear arrangement are isolated from the automated actuating mechanism to show internal components thereof;

FIG. 26 shows a partially sectioned top view of the latch mechanism of FIG. 17, showing a first lock body of a lock mechanism of the latch mechanism in an inactive configuration or position;

FIG. 27 shows a sectioned side view of a latch mechanism in accordance with a third example embodiment of the invention, comprising a catch formation formed on a catch body, in accordance with the invention;

FIG. 28 shows a perspective view of an example embodiment of a first lock body used with any one of the preceding embodiments of the latch mechanism;

FIG. 29 shows a perspective view of an alternative example embodiment of a first lock body used with any one of the preceding embodiments of the latch mechanism; and

FIG. 30 shows a sectioned side view of the first lock body of FIG. 29.

### DESCRIPTION OF THE ILLUSTRATED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “engaged” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “engaged” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words or similar import. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Referring to the drawings, in which like numerals indicate like features, a non-limiting example of a latch mechanism in accordance with the invention is generally indicated by reference numeral 10.

As shown in the figures, the latch mechanism 10 takes the form of a pressure plate latch or pressure lever lock or latch mechanism (hereinafter “latch mechanism” or simply “latch”). The latch mechanism 10 comprises a main body 14 which is mounted to a structure 16, which in the examples shown in the figures, takes the form of a door. The bulk of the mechanical components that make up the latch mechanism 10 is operatively arranged towards an inner volume 18 defined by the structure 16.

The latch 10 comprises a latch body 20, which is pivotably fixed relative to a handle body 12 of the latch 10. The handle body 12, in turn, is pivotably fixed to the main body 14. The latch body 20 has a latch surface 22, which is configured, when the latch 10 is in a latched configuration, to catch onto a catch formation 24, formed on the main body 14. The latch body 20 also comprises a pressure plate 26, which is used to actuate the latch body 20, by exerting an external force or pressure thereon, thereby causing the latch body 20 to pivot (in cases where a lock mechanism is configured in an unlocked configuration, as discussed more fully below) relative to the handle body 12, causing the latch surface 22 to unlatch from the catch formation 24. This allows the handle body 12 to pivot away from the main body 14. The handle body 12 is biased away from the main body 14. The latch body 20 is biased towards a position taken when in the latched configuration.

A main latch formation 28 which is connected to or integrally formed with the handle body 12, is released from a secondary structure 30 when the handle body 12 is pivoted relative to the main body 14, and therefore, when the latch 10 is configured in the unlatched configuration. The structure 16 (door) is therefore no longer retained by the latch 10 relative to the secondary structure 30, and the structure 16 may be opened.

The latch mechanism 10 furthermore comprises a lock mechanism 32. The lock mechanism 32 is provided for locking the latch mechanism 10 in such a way that a force or pressure applied to the pressure plate 26 does not cause the latch mechanism 10 to be configured to the unlatched configuration.

The lock mechanism 32 defines a lock opening 34, which is best shown schematically in FIGS. 10 to 15. The configuration of the latch mechanism 10 is such that an extension 36 of the latch body 20 is located proximate the lock opening 34 when the latch mechanism 10 is in the latched configuration. As will be discussed in more detail below, the lock mechanism 32 is configurable between an unlocked configuration, and a locked configuration. When in the unlocked configuration, the extension 36 of the latch body 20 can be displaced into the lock opening 34, and therefore the latch body 20 is pivotable relative to the handle body 12, as discussed above. When in the locked configuration, however, and as discussed more fully below, the extension 36 is inhibited from being displaced into the lock opening 34, thereby inhibiting pivoting of the latch body 20, preventing the latch surface 22 from unlatching from the catch formation 24.

The lock mechanism 32 comprises a first lock body 38 and a second lock body 40. The first and second lock bodies (38, 40) are independently displaceable relative to one another. The first and second lock bodies (38, 40) are both pivotably displaceable about a single axis of rotation 42 in this example. It will be appreciated, that in example embodiments not shown herein, it is possible for the first and second lock bodies (38, 40) to be linearly displaceable relative to one another, or for one or more linear actuators to serve as lock bodies. This will not be discussed further.

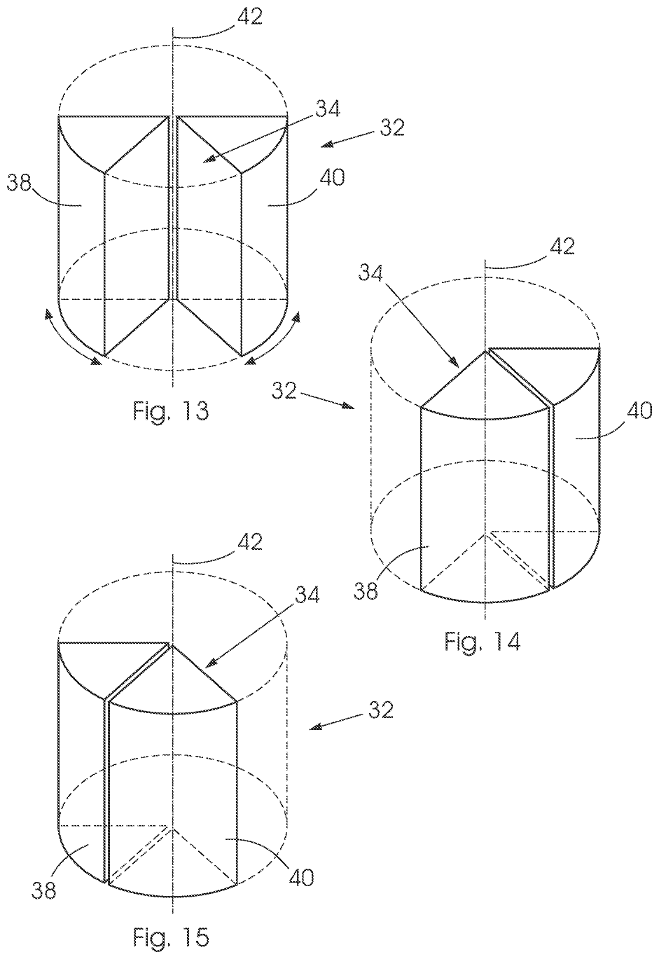

As shown schematically in FIGS. 10 and 13, when the lock mechanism 32 is in the unlocked configuration the first and second lock bodies (38, 40) are both displaced or located outside of the lock opening 34, such that the lock opening 34 is open or free from obstructions, allowing the extension 36 of the latch body 20 to be displaced thereinto.

When the lock mechanism 32 is configured in the locked configuration, either the first lock body 38 or the second lock body 40 is displaced into the lock opening 34, thereby blocking or obstructing the lock opening 34, and inhibiting the extension 36 of the latch body 20 from being displaced thereinto. This is shown for example, in FIGS. 11, 12, 14 and 15.

The first and second lock bodies (38, 40) are independently actuatable. The latch mechanism 10 includes an automated actuating mechanism 44 with which the first lock body 38 is actuated or displaced.

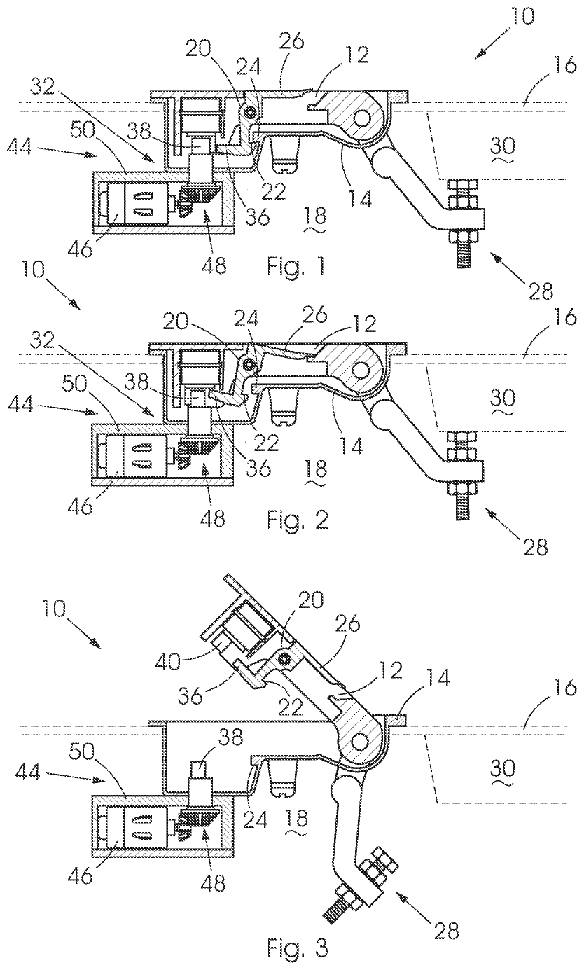

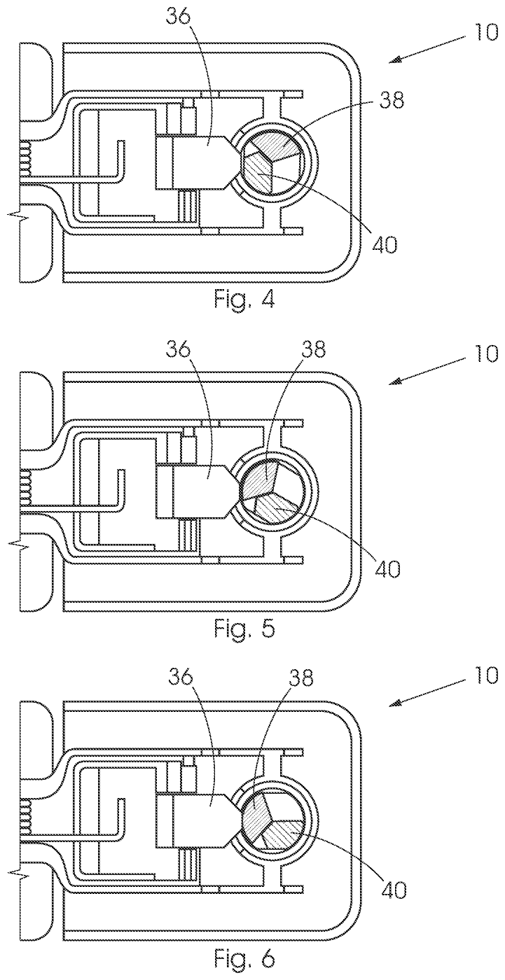

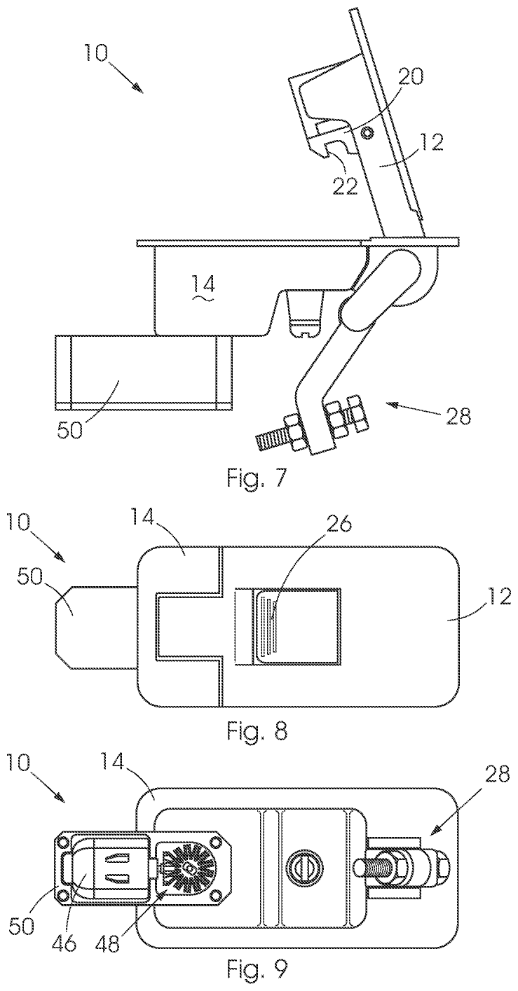

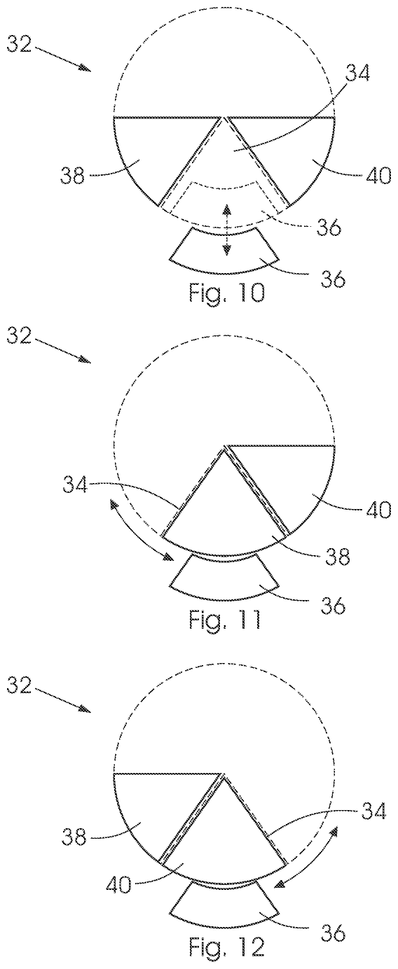

The automated actuating mechanism 44 comprises an electronic motor 46 and a gear arrangement 48, in the first example embodiment shown in FIGS. 1 to 9, taking the form of a bevel gear arrangement. The electric motor 46 is fixed or housed in a housing 50, which is fixed to the main body 14. Therefore, the first lock body 38 may be pivotably fixed and supported relative to the main body. A shaft (not shown) associated with the gear arrangement 48 protrudes through the main body 14 and supports the first lock body 38.

The second lock body 40, on the other hand, is supported by being pivotably fixed relative to the handle body 12. Typically, the second lock body 40 is actuated and displaced by means of a conventional key, from outside of the structure 16. Displacement or actuation of the second lock body 40 is therefore a manual operation.

When the handle body 12 is pivoted relative to and away from the main body 14, the first and second lock bodies (38, 40) are displaced away from one another (being supported by the main body 14 and handle body 12, respectively).

However, when the handle body 12 is pivoted towards the main body 14, and the latch mechanism 10 is therefore configured in the latched configuration, the first and second lock bodies (38, 40) are arranged in close proximity to one another, approximately on a similar longitudinal level relative to the axis 42, in an almost “meshed” configuration. In other words, when the latch mechanism 10 is in the latched configuration, the first and second lock bodies (38, 40) are situated proximate and relatively close to one another, without physically interfering with one another. The first and second lock bodies (38, 40) are therefore complementary in shape and configuration.

It also be appreciated that the intention is for only one of the two lock bodies to be located or displaced into the lock opening 34 when the lock mechanism 32 is configured into the locked configuration. A clutch or slip mechanism may be provided to allow one of the lock bodies, when actuated, to push the other lock body out of the lock opening 34. This is not discussed in more detail.

The first and second lock bodies (38, 40) are therefore configurable between an inactive configuration, where the respective lock bodies are displaced to a position outside of the lock opening 34, and an active configuration, in which the respective lock body is displaced at least partially into the lock opening 34. Therefore, as discussed above, the intention is for only a single one of the lock bodies to be configured in the active configurations at a time.

Typically, though not exclusively, the lock bodies (38, 40) may have a cross-sectional shape of a ring segment or a pin.

The gear arrangement 48 may have a ratio selected to ensure a sufficient amount of torque is exerted on the first lock body to displace same into the active configuration, and even, where necessary, to push the second lock body 40 out of the lock opening 34, towards its respective inactive configuration. The gear ratio may typically be 1:49.

The latch mechanism 10 is associated with a control unit 52, which is configured for controlling some of the functionality of the automated actuating mechanism, and the like. As will be discussed in more detail below, a single control unit 52 may be used in the course of controlling more than one latch mechanism 10.

The control unit 52 typically comprises a receiver such as a radio frequency (RF) receiver 54 which may receive commands from a command module, such as a remote controller 56. The control unit 52 also includes a memory module 58 and a processor 60, which processes and controls inputs to, and outputs from, the control unit 52.

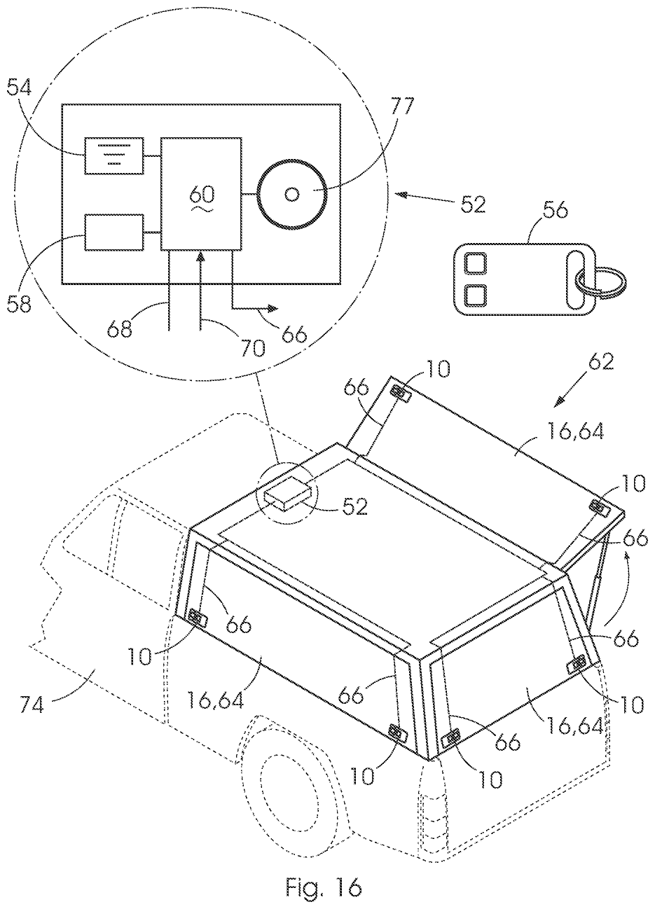

Reference is now made to FIG. 16, where the latch mechanism 10 is employed in use, as part of a larger structure, here taking the form of a canopy 62 of a pick-up truck or vehicle 74. The canopy is associated with three doors 64 (serving as the structure 16 discussed above), all of which are fitted with two latch mechanisms 10, used for releasably retaining the doors 64 in a closed configuration, in known fashion. All the latch mechanisms 10 form part of a single, integrated system, which is controlled by a single control unit 52.

Communication lines 66, such as electrical or optic wire run between the control unit 52 and the various latch mechanisms 10.

Typically, the control unit is connected, by means of a power cable 68, to a power source, such as a battery of the vehicle (not shown).

The controller therefore controls the various automated actuating mechanisms 44 of the latch mechanisms 10. An input received from the remote controller 56 may therefore prompt the processor 60 to cause all the lock mechanisms 32 of the latch mechanisms 10 to be configured towards one of the locked or unlocked configurations. The second lock bodies 40 are provided for manually locking or unlocking the latch mechanisms 10.

In the example shown in FIG. 16, the canopy 62 is further fitted with at least one sensor device (not shown), provided in communication with the control unit 52 by means of a communication line 70. The sensor device may take the form of a motion detector device, a smoke detector device, a temperature sensing device, a sound detector device, a proximity switch, door or window sensors, light sensors, or the like. The control unit may be associated with a siren or alarm module 72, which may sound an alarm, based on, for example, an input provided by the sensor device (for example, taking the form of a motion or proximity switch, indicating tampering with the canopy 62 or illicit opening of one of the doors).

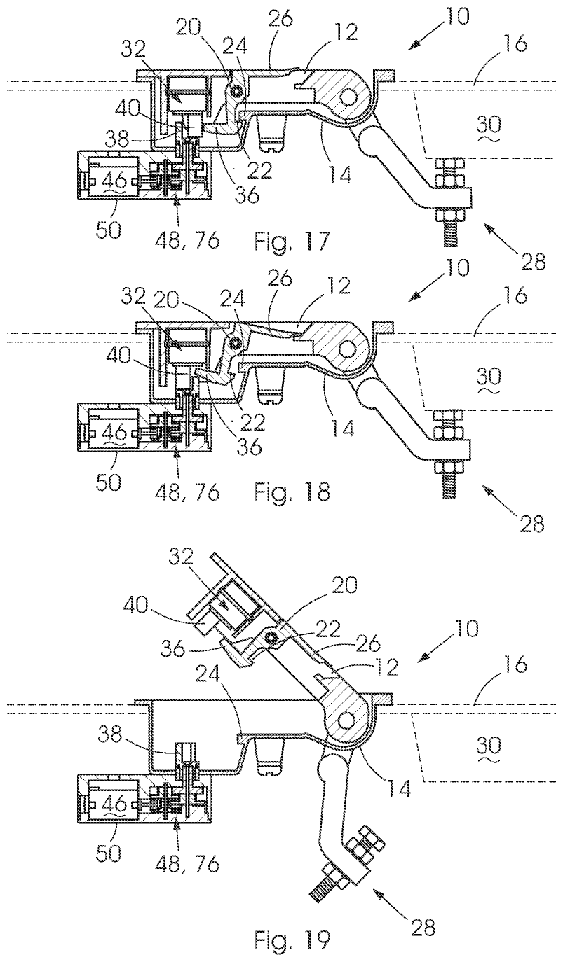

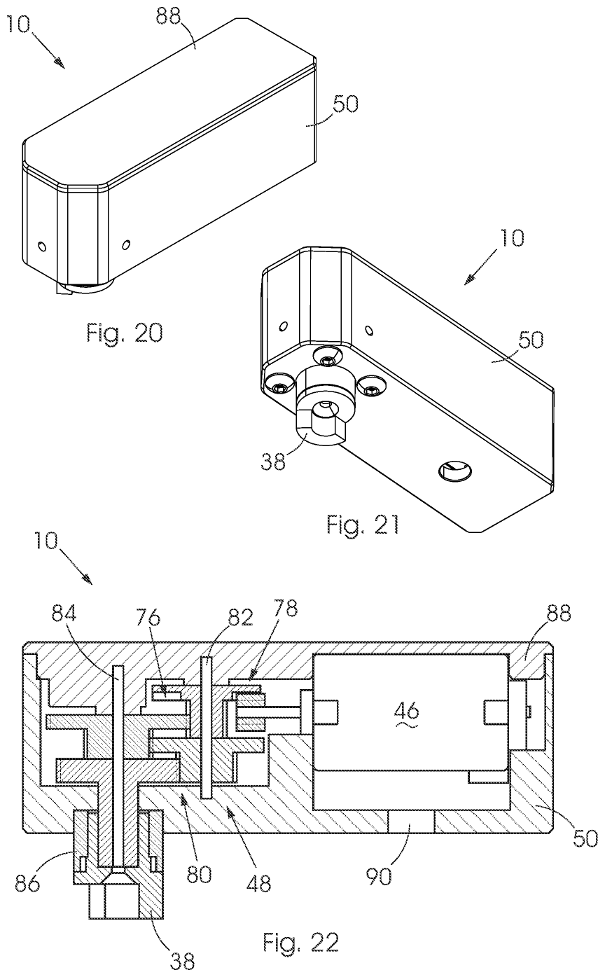

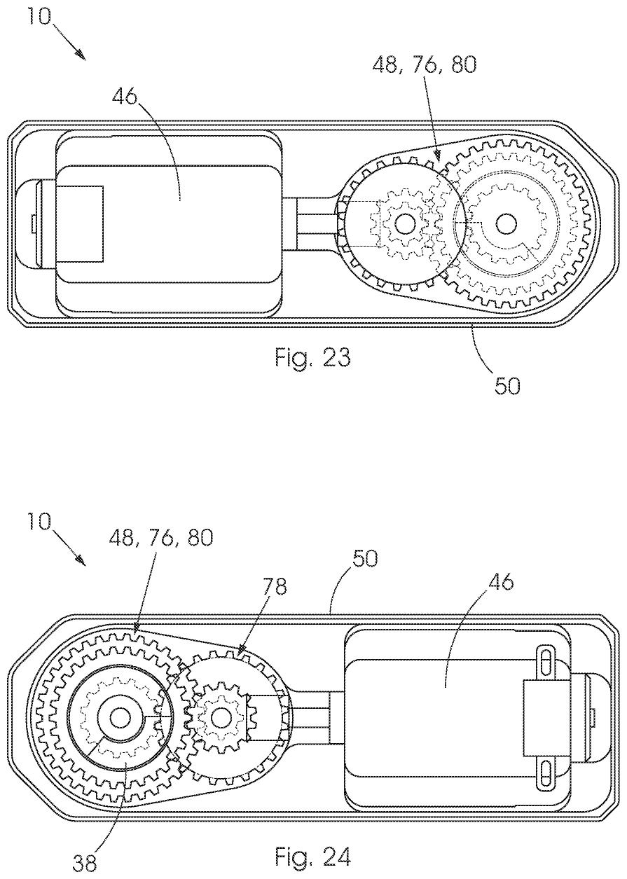

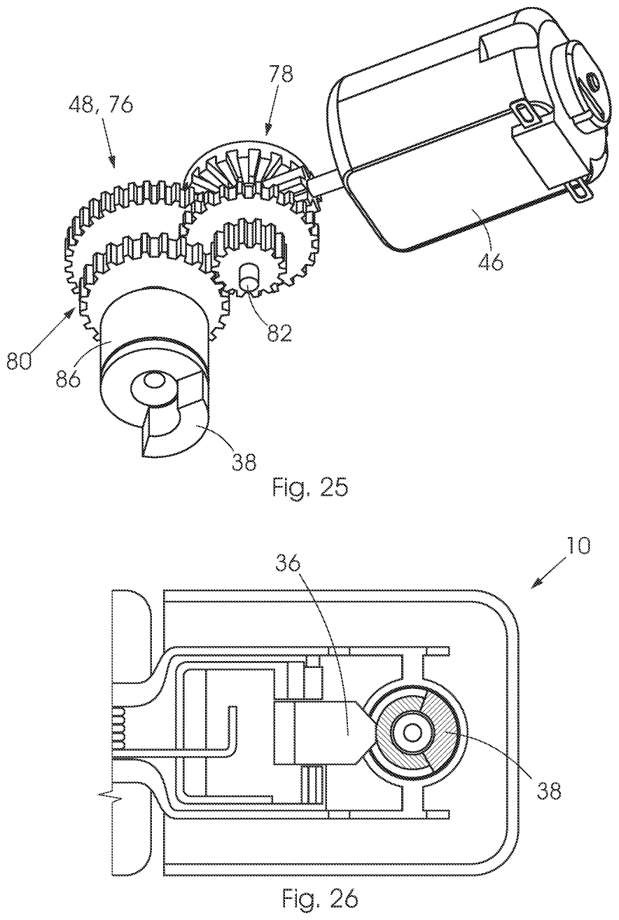

A second example embodiment of the latch mechanism 10 is shown in FIGS. 17 to 26. The second example embodiment of the latch mechanism differs only slightly from the first example embodiment, and only differences between the two will be discussed herein. Like numerals used with respect to the various embodiments indicate like or similar features.

The gear arrangement 48 of the second example embodiment comprises a multistage gear arrangement or gearbox 76 with an increased gear ratio (compared to the gear arrangement of the first embodiment). The multistage gearbox 76 typically has a gear ratio of 1:90, which increases torque available to displace the first lock body 38 (and potentially to move the second lock body 40 out of position if necessary). The multistage gearbox 76 comprises a bevel gear arrangement 78, a number of interacting spur gears 80 and first and second shafts (82, 84). The gears of the multistage gearbox 76 is typically manufactured from metal, such as steel, stainless steel or aluminium, to facilitate transfer of torque, but may alternatively also be manufactured from plastic. The housing 50 is adapted to support the multistage gearbox 76 and more particularly, the first and second shafts (82, 84). A support ring 86 is provided to support the first lock body 38. The first lock body 38 now also includes an integral stopper body (not shown), which interacts with a complementary stopper body on the support ring 86, to limit rotation of the first lock body 38 and act as a positive rotation stopper. The latch mechanism 10 may include an electrical plug or socket arrangement (not shown) to enable easy fitment and connection of the latch mechanism 10 to the communication lines 66. The housing 50 may include a removable lid 88 which may be fitted to the housing 50 by means of a press-fit arrangement or by means of screws or other mechanical fasteners. Seals, such as O-rings may be provided between the support ring 86 and the first lock body 38 and between the housing 50 and the lid 88. Alternatively, or in addition, the housing 50 may include a drainage hole 90 for allowing water to drain from the housing 50.

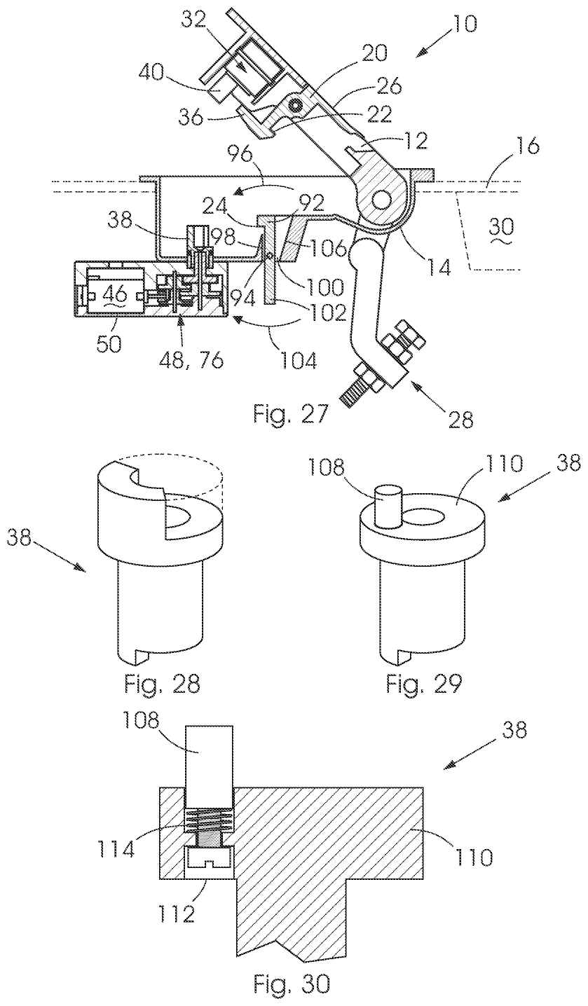

Reference is next made to FIGS. 27 to 30 where alternative embodiments of some of the features and components of the latch 10 are shown. It will be appreciated that the alternative embodiments of these features may be incorporated with any of the aforementioned embodiments, unless the context dictates otherwise, or may provide standalone aspects of the disclosure.

FIG. 27 shows a latch 10 of which the catch formation 24 is formed on a catch body 92, which is pivotably mounted relative to the main body 14 via a pivot 94. The catch body 92 is biased (by means of a biasing means such as a torsion spring or the like which is not shown) in a first direction (indicated by arrow 96) about the pivot 94. The biasing means biases the catch body 92 into an operative position (the position shown in FIG. 27), in which the catch body 92 is pushed or urged against a stop formation 98 of the main body 14. The stop formation 98 therefore limits the permissible amount of pivoting of the catch body 92 in the first direction 96 under the bias of the biasing means. The catch body 92 protrudes through an opening 100 of the main body 14 and includes a handle portion 102 which is operatively located or accessible from an inside of the structure 16 (or rather, on a side opposite to a side from which the pressure plate 26 is operated under normal circumstances). The handle portion 102 is used to displace the catch body 92 against the bias in a second direction (shown by the arrow 104). The amount of permissible pivoting against the bias in the second direction 104 is limited by a second stop formation 106 forming part of the main body 14.

The catch body 92 may therefore be displaced in the second direction 104 into an inoperative position, in which the catch formation 24 and the latch surface 22 cannot interact (even when the latch surface 22 is stationary and not displaced by means of pressure or a force applied to the pressure plate 26). This has three immediate results or effects:

Firstly, a person on an inside of the structure 16 can unlatch the latch 10 (whether the lock mechanism 32 is locked or unlocked), which is not possible when using conventional pressure plate latches.

Secondly, if the second lock body 40 is moved into the lock opening 34 to provide the lock mechanism 32 in the locked configuration while the latch 10 is unlatched, displacement of the latch surface 22 will, absent the use of the pivotable catch body 92, be inhibited, and the latch 10 will therefore not be configurable into the latched configuration. However, interaction between the latch surface 22 and the catch body 92 (when the latch is moved towards a latched configuration) causes the catch body 92 to be displaced under the bias to the inoperative position, allowing the latch to be depressed to a position where it would normally be located in a latched configuration. A chamfered edge of the latch surface 22 and/or the catch body 92 facilitates such interaction. Once in this position, the catch body 92 will snap back into the operative position under the bias, and the latch 10 will be provided in the latched (and locked) configuration.

Thirdly, if the first lock body 38 is moved into the lock opening 34 to provide the lock mechanism 32 in the locked configuration while the latch 10 is unlatched, displacement of the latch surface 22 will, absent the use of the pivotable catch body 92, be inhibited. However, when such a pivotable catch body 92 is present, interaction between the extension 36 of the latch body and the first lock body 38 (again, facilitated by a chamfered edge of the extension 36) now pushes the lock body 20 to be displaced against its bias, following which the latch surface 22 and the catch body 92 again causes the catch body 92 to be displaced under the bias to the inoperative position, allowing the latch to be depressed to a position where it would normally be located in a latched configuration. Once in this position, the catch body 92 will again snap back into the operative position under the bias, and the latch 10 will be provided in the latched (and locked) configuration.

It will be appreciated that the catch body 92 may take other forms which are not shown, whilst achieving the same effects or results as discussed above. For example, the catch body 92 may be axially displaceable between operative and inoperative positions, may slide to the side to an inoperative position, or may be formed as a cam body which may be rotated out of position towards an inoperative position. In general terms, the catch body 92 is therefore displaceable such that, in the inoperative position or configuration, the catch formation 24 and latch surface 22 cannot interact with each other. It will furthermore be appreciated that the displacement of the catch body 92 may be automated by means of an automated actuating mechanism which may be substantially similar to the automated actuating mechanism 44 used to actuate the first lock body. If so automated, the press of a button could allow the unlatching of the latch mechanism 10 altogether, even when the lock mechanism 32 is in the locked configuration. This is not shown in the figures.

It will be appreciated that the use of a displaceable catch body 92 as detailed herein may be used with pressure lever latches of the conventional kind, not including lock mechanisms 32 having automated actuating mechanisms 44. Such implementations fall within the scope of this disclosure.

In some cases, it may be possible to mount the catch body 92 relative to the housing 50.

Furthermore, it will be appreciated that the object of opening the latch 10 from the inside may furthermore be achieved by providing a displaceable actuating lever with which the latch body 20 itself may be pushed away from the catch formation 24. This will naturally only be achievable when the lock mechanism 32 is in an unlocked configuration.

FIGS. 29 and 30 show an alternative embodiment of the first lock body 38. Here the lock body is formed by a lock pin 108, which is axially displaceable relative to a lock body support collar 110. The lock pin 108 is received in a bore 112 and is biased by means of a spring 114 to an outward position. An axial force from above therefore allows the lock pin 108 to retract into the collar 110 to an inoperative position. Once said axial force is removed, the pin 108 extends back to an operative position. In cases where the latch 10 is unlatched, and both the first and second lock bodies (38, 40) are moved into a locked or active configuration, physical interference will occur between the two lock bodies (38, 40) when the latch is moved towards the latched configuration (since both lock bodies (38, 40) will then, theoretically, occupy the lock opening 34). However, since the lock pin 108 is axially displaceable, the second lock body 40 will simply displace the lock pin 108 into the collar 110, allowing the latch to be configured into the latched (and locked) configuration. It will be appreciated that the above presumes the use of the pivotable catch body 92 discussed above. If the first lock body 40 is later unlocked or moved to the inactive position, the spring 114 will push the lock pin upwards, and the latch 10 will remain locked (since the pin 108 will now be located within the lock opening 34).

It will be appreciated that the second lock body 40 could, alternatively or in addition, take the form of the lock pin as described above, yielding the same results. Furthermore, an embodiment where the first lock body 38 in its entirety (as shown in FIG. 28) is axially displaceable would also be feasible. Some structural changes to the latch 10, which a person of reasonable skill in the art would be able to appreciate, would be required in such a case. Such alternatives form part of the present disclosure.

The system may therefore function as a “central locking” system, with integrated safety measures, such as alarm systems and the like.

The larger structure may take various other forms, such as a container, a trailer, a caravan, and the like (this list is not intended to be limited).

It will be appreciated that the above description only provides example embodiments of the invention and that there may be many variations without departing from the spirit and/or the scope of the invention.

In one example, the latch mechanism comprises only a single lock body 38, which is actuated by the automated actuating mechanism as discussed above.

Furthermore, the gear arrangement is not limited to bevel or spur gear arrangements. For example, worm gears, rack and pinion arrangements, spur and crown arrangements and other known gear arrangements may alternatively be used. Also, alternative transfer arrangements, such as linkages, chains and sprockets, belts and pulleys and the like may also be used.

Other gear ratios may also be employed, depending on the type of gear or transfer arrangement, actuating mechanism used, and the like.

Alternative wireless communication protocols, signals and the like may also be used to receive prompts or instructions at the control unit. For example, the use of RFID, WIFI, Bluetooth, IoT and the like may be feasible.

The automated actuating mechanism may include alternative actuating means (instead of a conventional electrical motor), such as stepper motors, VSD motors or drives, servos, linear actuators such as hydraulic or pneumatic actuators, magnetic actuators and the like. Concomitant, changes to the gear or transfer arrangement, as are known in the art, will have to be made.

Communication lines 66 may be replaced by wireless communication arrangements between the control unit and the respective latch mechanisms 10.

It will easily be understood from the present application that the particular features of the present invention, as generally described and illustrated in the figures, can be arranged and designed according to a wide variety of different configurations. In this way, the description of the present invention and the related figures are not provided to limit the scope of the invention but simply represent selected embodiments.

The skilled person will understand that the technical characteristics of a given embodiment can in fact be combined with characteristics of another embodiment, unless otherwise expressed or it is evident that these characteristics are incompatible. Also, the technical characteristics described in a given embodiment can be isolated from the other characteristics of this embodiment unless otherwise expressed.

1. A latch mechanism comprising a latch body and a lock mechanism comprising first and second lock bodies which are displaceable independently relative to each other, the lock mechanism defining a lock opening and being configurable in one of:
an unlocked configuration, in which the lock opening is open allowing a portion of the latch body to be displaceable thereinto to cause the latch body to unlatch from a catch formation; and
a locked configuration, in which at least one of the first and second lock bodies is displaced at least partially into the lock opening, thereby inhibiting the portion of the latch body from being displaced into the lock opening.

2. The latch mechanism according to claim 1, wherein the first and second lock bodies are pivotably displaceable relative to each other about an axis of rotation.

3. The latch mechanism according to claim 1, wherein each of the first and second lock bodies has a cross-sectional shape of one of a ring segment and pin.

4. The latch mechanism according to claim 1, wherein each of the first and second lock bodies is displaceable between an active and inactive configuration and wherein, when the first and second lock bodies are configured in their respective inactive configurations, the first and second lock bodies are located proximate each other in adjoining fashion, without physical interference between the first and second lock bodies, while defining between them, the open lock opening.

5. The latch mechanism according to claim 1, wherein the first lock body is pivotably supported relative to a main body of the latch mechanism, while the second lock body is pivotably supported by a handle portion of the latch.

6. The latch mechanism according to claim 1, further comprising an automated actuating mechanism for displacing the first lock body.

7. The latch mechanism according to claim 6, wherein the automated actuating mechanism comprises an electronic actuating mechanism comprising an electric motor associated with a gear arrangement, the gear arrangement configured to displace the first lock body.

8. The latch mechanism according to claim 7, wherein the gear arrangement has a gear ratio selected to ensure a sufficient amount of torque is exerted on the first lock body to pivotably displace same between active and inactive configurations.

9. The latch mechanism according to claim 8, wherein the gear ratio is between 1:40 and 1:100.

10. The latch mechanism according to claim 7, wherein the gear arrangement comprises one of a bevel gear arrangement, spur gear arrangement, worm gear arrangement, spur and crown arrangement, rack and pinion arrangements and a multistage gear arrangement.

11. The latch mechanism according to claim 6, wherein the automated actuating mechanism is received within a housing which is fixed to a main body of the latch mechanism and wherein the first lock body or a drive body associated with the first lock body extends at least partially through an opening in the main body of the latch mechanism.

12. The latch mechanism according to claim 11, wherein the first lock body or the drive body is supported by a support ring which extends from the housing, and wherein the support ring comprises a limiting formation, provided for interacting with a complementary shoulder or stopper formation on the first lock body or drive body, for limiting a range of permissible displacement of the first lock body.

13. The latch mechanism according to claim 7, further comprising a control unit operatively connected to a power source and including a receiving means in the form of a radio receiver, configured for receiving a signal from a command module, wherein the signal is selected from a group comprising: a radio frequency (RF) signal, an RFID signal, a WIFI signal, a Bluetooth signal, and an IoT signal, and wherein the control unit is configured for causing the electric motor to actuate the first lock body based on a command received from the command module.

14. The latch mechanism according to claim 1, wherein the second lock body is configured to be actuated by external means in the form of a key which is turned to displace the second lock body between active and inactive configurations.

15. The latch mechanism according to claim 1, taking the form of a pressure plate latch mechanism or pressure lever lock or latch mechanism.

16. The latch mechanism according to claim 1, wherein the catch formation is formed on a catch body which is displaceable relative to a main body of the latch mechanism between an operative and inoperative position.

17. The latch mechanism according to claim 16, wherein the catch body is biased towards the operative position.

18. The latch mechanism according to claim 16, wherein the catch body comprises an extension which extends through an opening in the main body and defines a handle portion, facilitating manual displacement of the catch body towards the inoperative position.

19. The latch mechanism according to claim 16, wherein the catch body is one of: pivotably displaceable relative to the main body; axially displaceable relative to the main body; sideways-slidably displaceable relative to the main body; and rotatably displaceable relative to the main body.

20. The latch mechanism according to claim 16, further comprising an automated actuating mechanism provided for displacing the catch body between the operative and inoperative positions.

21. The latch mechanism according to claim 1, further comprising a displaceable actuating lever extending from a rear side of the latch mechanism and which interacts with the latch body, with which the latch body may be displaced to unlatch from the catch formation.

22. The latch mechanism according to claim 1, wherein one of the first and second lock bodies is axially displaceable between an extended and retracted position, and wherein the relevant one of the first and second lock bodies is biased towards the extended position.

23. The latch mechanism according to claim 22, wherein the relevant one of the first and second lock bodies comprises a lock pin which is supported by a lock body support collar.

24. A latch mechanism comprising a latch body and a lock mechanism comprising a first displaceable lock body, the lock mechanism defining a lock opening and being configurable in one of
an unlocked configuration, in which the lock opening is open allowing a portion of the latch body to be displaceable thereinto to cause the latch body to unlatch from a catch formation; and
a locked configuration, in which the first lock body is displaced at least partially into the lock opening, thereby inhibiting the portion of the latch body from being displaced into the lock opening,
the latch mechanism further comprising an automated actuating mechanism for displacing the first lock body.

25. The latch mechanism according to claim 24, wherein the automated actuating mechanism comprises an electronic actuating mechanism comprising an electric motor associated with a gear arrangement, the gear arrangement configured to displace the first lock body.

26. The latch mechanism according to claim 25, wherein the gear arrangement has a gear ratio selected to ensure a sufficient amount of torque is exerted on the first lock body to pivotably displace same between active and inactive configurations.

27. The latch mechanism according to claim 26, wherein the gear ratio is between 1:40 and 1:100.

28. The latch mechanism according to claim 26, wherein the gear arrangement comprises one of a bevel gear arrangement, spur gear arrangement, worm gear arrangement, spur and crown arrangement, rack and pinion arrangements and a multistage gear arrangement.

29. The latch mechanism according to claim 24, wherein the automated actuating mechanism is received within a housing which is fixed to a main body of the latch mechanism and wherein the first lock body or a drive body associated with the first lock body extends at least partially through an opening in the main body of the latch mechanism.

30. The latch mechanism according to claim 29, wherein the first lock body or the drive body is supported by a support ring which extends from the housing, and wherein the support ring comprises a limiting formation, provided for interacting with a complementary shoulder or stopper formation on the first lock body or drive body, for limiting a range of permissible displacement of the first lock body.

31. The latch mechanism according to claim 25, further comprising a control unit operatively connected to a power source and including a receiving means in the form of a radio receiver, configured for receiving a signal from a command module, wherein the signal is selected from a group comprising: a radio frequency (RF) signal, an RFID signal, a WIFI signal, a Bluetooth signal, and an IoT signal, and wherein the control unit is configured for causing the electric motor to actuate the first lock body based on a command received from the command module.

32. The latch mechanism according to claim 24, comprising a second lock body which is displaceable independently relative to the first lock body.

33. The latch mechanism according to claim 24, taking the form of a pressure plate latch mechanism or pressure lever lock or latch mechanism.

34. The latch mechanism according to claim 24, wherein the catch formation is formed on a catch body which is displaceable relative to a main body of the latch mechanism between an operative and inoperative position.

35. The latch mechanism according to claim 34, wherein the catch body is biased towards the operative position.

36. The latch mechanism according to claim 34, wherein the catch body comprises an extension which extends through an opening in the main body and defines a handle portion, facilitating manual displacement of the catch body towards the inoperative position.

37. The latch mechanism according to claim 34, wherein the catch body is one of: pivotably displaceable relative to the main body; axially displaceable relative to the main body; sideways-slidably displaceable relative to the main body; and rotatably displaceable relative to the main body.

38. The latch mechanism according to claim 34, further comprising an automated actuating mechanism provided for displacing the catch body between the operative and inoperative positions.

39. The latch mechanism according to claim 24, further comprising a displaceable actuating lever extending from a rear side of the latch mechanism and which interacts with the latch body, with which the latch body may be displaced to unlatch from the catch formation.

40. The latch mechanism according to claim 32, wherein one of the first and second lock bodies is axially displaceable between an extended and retracted position, and wherein the relevant one of the first and second lock bodies is biased towards the extended position.

41. The latch mechanism according to claim 40, wherein the relevant one of the first and second lock bodies comprises a lock pin which is supported by a lock body support collar.

42. A latch mechanism comprising a latch body, a catch formation, and a lock mechanism comprising a first displaceable lock body, the lock mechanism defining a lock opening and being configurable in one of
an unlocked configuration, in which the lock opening is open allowing a portion of the latch body to be displaceable thereinto to cause the latch surface to unlatch from the catch formation; and
a locked configuration, in which the first lock body is displaced at least partially into the lock opening, thereby inhibiting the portion of the latch body from being displaced into the lock opening,
wherein the catch formation is formed on a catch body which is displaceable relative to a main body of the latch mechanism between an operative and inoperative position.

43. The latch mechanism according to claim 42, wherein the catch body is biased towards the operative position.

44. The latch mechanism according to claim 42, wherein the catch body comprises an extension which extends through an opening in the main body and defines a handle portion, facilitating manual displacement of the catch body towards the inoperative position.

45. The latch mechanism according to claim 42, wherein the catch body is one of: pivotably displaceable relative to the main body; axially displaceable relative to the main body;
sideways-slidably displaceable relative to the main body; and rotatably displaceable relative to the main body.

46. The latch mechanism according to claim 42, further comprising an automated actuating mechanism provided for displacing the catch body between the operative and inoperative positions.

47. The latch mechanism according to claim 42, further comprising a displaceable actuating lever extending from a rear side of the latch mechanism and which interacts with the latch body, with which the latch body may be displaced to unlatch from the catch formation.

48. The latch mechanism according to claim 42, taking the form of a pressure plate latch mechanism or pressure lever lock or latch mechanism.

49. A structure defining an internal volume, the structure including at least one door which is provided with one or more latch mechanisms in accordance with claim 1, claim 24 or claim 42.

50. The structure according to claim 49, further comprising a control unit for controlling automated actuating mechanisms of the one or more latch mechanisms.

51. The structure according to claim 50, comprising at least a first sensor device provided in communication with the control unit, wherein the control unit is associated with a siren or alarm module and wherein the first sensor device is selected from a list comprising: a motion detector device; a smoke detector device; a temperature sensing device; a sound detector device; a door or window proximity sensor; and a light sensor.

52. The structure according to claim 49, wherein the structure comprises one of: a canopy; a container; a trailer; a caravan; a camper; a car top carrier; a luggage box; a motor bike top boxes or pannier; a cubbyhole; a glove box; a cupboard; a service hatch; an access door; a toolbox; a security door; a flatbed tray; a gullwing door; a drawer; a safe; a safety deposit box; a slider; a load-bay cover of a pick-up truck; a roller door; a shutter or roller shutter a luggage compartment; and a door and/or window of a dwelling.
